(19) United States
(12) Patent Application Publication
(10) Pub. No.: US 2018/0042032 A1
(43) Pub. Date: Feb. 8, 2018

(54) A Method for Resource Release

(71) Applicant: Nokia Solutions and Networks Oy, Espoo (FI)

(72) Inventors: Ping YUAN, Beijing (CN); Hui Yu YUAN, Beijing (CN); Tianyang QI, Zhejiang (CN)

(21) Appl. No.: 15/551,077

(22) PCT Filed: Feb. 17, 2015
(86) PCT No.: PCT/CN2015/073219

§ 371 Date: Aug. 15, 2017

(51) Int. Cl. H04W 72/12; H04W 88/08; G06F 11/08; H04W 72/04; H04L 1/18

(52) U.S. Cl. CPC H04W 72/12; H04W 72/04; H04L 1/1854; G06F 11/08; H04W 88/08

(57) ABSTRACT

A method is provided for handling resources for uplink semi-persistent scheduling transmission, wherein the resources are reserved periodically for a specific service, the method including monitoring data transmitted on the semi-persistent scheduling reserved resources and dynamic scheduled resource, checking whether a specific data element related to the specific service has not been received consecutively for a predefined period on the semi-persistent scheduling reserved resources and dynamic scheduled resource, and determining, when the specific data element has not been received for the predefined period, that the use of the specific service has ended. When it is determined that the use of the specific service has ended, an explicit release for the semi-persistent scheduling reserved resources may be triggered.

### FIELD OF THE INVENTION

The present invention relates to an apparatus, a method and a computer program product improving a radio resource release.

### RELATED BACKGROUND ART

The following meanings for the abbreviations used in this specification apply:

### DL Downlink

### DS Dynamic Scheduling

eNB evolved NodeB

### FDD Frequency Division Duplex

### LTE Long Term Evolution

### MAC Medium Access Control

### MCS Modulation and Coding Scheme

### PDCCH Physical Downlink Control Channel

### PDN Packet Data Network

### PRB Physical Resource Block

### PUSCH Physical Uplink Shared Channel

### QCI QoS Class Identifier

### QoS Quality of Service

### RSU Ratio of Satisfied User

### SDU Service Data Unit

### SPS Semi-persistent Scheduling

### TDD Time Division Duplex

TTI Transmission time interval
UE User equipment

### UL Uplink

VoIP Voice over Internet Protocol
VoLTE Voice over LTE

Embodiments of the present invention relate to the field of mobile radio communications, and in particular to allocating radio resources to UEs. One method for allocating resources uses Uplink Semi-persistent Scheduling. Uplink Semi-persistent Scheduling (UL SPS) is a feature aiming at improving the network capacity in DL control channel (PDCCH) limited scenario. Applications like VoLTE have regular packet arrival ratio and small packet size. It might use up PDCCH resources while PUSCH resources are still available.

SPS enables the eNB to allocate radio resources to UEs for a sequence of TTIs that repeat with a certain periodicity via one PDCCH signal. Given the periodic and predictable characteristics (in terms of packet size and frequency) of voice traffic generated from VoLTE calls, SPS can be used to reduce PDCCH signalling and increase the number of VoLTE users per cell in the scenario of PDCCH block.

For UL SPS, implicit release SPS configured grant is defined. As described in 3GPP TS 36.321 (V12.4.0) section 5.10, the UE shall clear the configured uplink grant immediately after implicitReleaseAfter number of consecutive new MAC PDUs each containing zero MAC SDUs have been provided by the Multiplexing and Assembly entity, on the Semi-Persistent Scheduling resource.

According to 3GPP description, eNB will count the number of empty MAC SDU receptions on the Semi-Persistent reserved resource, traffic on MAC SDU is not limited to VoLTE call. For UE with service including both voice and data, services with large amount of data to be transmitted filled up the MAC SDU during VoLTE silent period or even when voice service is finished. This may keep an uplink SPS grant for much longer time than needed. The implicit release doesn't work well in multi-service scenario. That can be explained by referring to FIG. 3, which illustrates an SPS scheduling scheme.

As shown, after the VoIP talk spurt ends, the UE will transmit data service on the reserved SPS TTI, even besides transmitting on a dynamically scheduled (DS) TTI. Thus, no empty MAC SDUs are transmitted, so that an implicit release cannot be triggered. Therefore, the SPS reserved resource is used by low priority services of the UE.

As mentioned above, according to the prior art, the eNB triggers UL SPS implicit release by the detection of consecutive new empty MAC PDU on the SPS reserved resource, which can work well while UE only has single voice bearer.

The performance is poor in this design when UE has multi-bearer services, due to the following reasons:

1. SPS is mainly used for small packet, that the MCS level is relatively low (maximum MCS=15 as defined in 3GPP 36.213). In good radio condition, the PRB usage efficiency is lower than dynamic scheduling.
2. PRB resource is occupied by the SPS UE with non-voice service, which cause no PRB resource for other high priority VoLTE UEs.

Both of above items may cause VoLTE RSU (Ratio of Satisfied User) downgrade.

This is illustrated by simulation results shown in FIGS. 4, 5 and 6A and 6B. FIG. 4 shows a diagram of RSU of VoIP service in 3GPP solution. When UL SPS is enabled, the performance gain for the multi-bearer scenario is poorer than that for the single-bearer scenario. FIG. 5 shows MCS and VoIP packet arrival in 3GPP solution for a single-bearer scenario. When UE comes to silent period, implicit release happens. User scheduling transforms from SPS scheduling to dynamic scheduling. When UE comes back to talk spurt, SPS can be reactivated. Implicit release in 3GPP solution can work well in the single-bearer scenario. FIGS. 6A and 6B show MCS and VoIP packet arrival in 3GPP solution for a multi-bearer scenario. When UEs talkspurt ends, SPS implicit release in 3GPP solution cannot be triggered if the transmitted MAC PDU is not empty, and thus SPS reserved resources are occupied by non-voice service. Thus, according to the prior art, there is the problem that SPS might lead to unnecessary reserving of resources.

### SUMMARY OF THE INVENTION

Some embodiments of the present invention address this situation and aim to overcome the above-described problem and to provide an improved mechanism in order to optimize radio resource usage, for example, in connection with SPS.

According to an example of an embodiment, there is provided, for example, a method for handling resources for semi-persistent scheduling transmission, wherein the resources are reserved periodically for a specific service, the method comprising monitoring data transmitted on the semi-persistent scheduling reserved resources and dynamic scheduled resource; checking whether a specific data element related to the specific service has not been received consecutively for a predefined period on the semi-persistent scheduling reserved resources and dynamic scheduled resource; and determining, when the specific data element has not been received for the predefined period, that the use of the specific service has ended.

Furthermore, according to an example of an embodiment, there is provided, for example, an apparatus comprising at least one processing circuitry, and at least one memory for storing instructions to be executed by the processing circuitry, wherein the at least one memory and the instructions are configured to, with the at least one processing circuitry, cause the apparatus at least: to handle resources for semi-persistent scheduling transmission, wherein the resources are reserved periodically for a specific service; to monitor data transmitted on the semi-persistent scheduling reserved resources and dynamic scheduled resource; to check whether a specific data element related to the specific service has not been received consecutively for a predefined period on the semi-persistent scheduling reserved resources and dynamic scheduled resource; and to determine, when the specific data element has not been received for the predefined period, that the use of the specific service has ended.

Furthermore, according to another example of an embodiment, there is provided, for example, an apparatus comprising means for handling resources for semi-persistent scheduling transmission, wherein the resources are reserved periodically for a specific service; means for monitoring data transmitted on the semi-persistent scheduling reserved resources and dynamic scheduled resource; means for checking whether a specific data element related to the specific service has not been received consecutively for a predefined period on the semi-persistent scheduling reserved resources and dynamic scheduled resource; and means for determining, when the specific data element has not been received for the predefined period, that the use of the specific service has ended.

According to still further example of an embodiment, there is provided, for example, a computer program embodied on a non-transitory computer readable medium, configured to control a processor to perform a method, the method comprising handling resources for semi-persistent scheduling transmission, wherein the resources are reserved periodically for a specific service; monitoring data transmitted on the semi-persistent scheduling reserved resources and dynamic scheduled resource; checking whether a specific data element related to the specific service has not been received consecutively for a predefined period on the semi-persistent scheduling reserved resources and dynamic scheduled resource, and determining, when the specific data element has not been received for the predefined period, that the use of the specific service has ended.

According to further refinements, these examples may include one or more of the following features:

The semi-persistent scheduling resources may comprise semi-persistent scheduling transmission subframes and the dynamic scheduled resource comprises dynamic scheduling transmission subframes, wherein the monitoring of data may comprise monitoring data transmitted on consecutive semi-persistent scheduling transmission subframes on the reserved resource, and monitoring data on the dynamic scheduling transmission subframes, wherein it may be checked whether the specific data element has not been received on consecutive semi-persistent scheduling transmission subframes and on the dynamic scheduling transmission subframes.

Moreover, an explicit release for the semi-persistent scheduling reserved resources may be triggered when it is determined that the use of the specific service has ended.

The predefined period may monitored by means of a counter, wherein the counter may be incremented or decremented each time a semi-persistent scheduling transmission subframe is received in which no specific data element related to the specific service is detected, wherein it may be determined that the period has elapsed when a certain value is reached.

The counter may be reset upon detecting the specific data element on a semi-persistent scheduling transmission subframe and/or the dynamic scheduling transmission subframes.

The predefined period may be defined by a predefined count value, wherein the predefined count value is defined such that it is larger than a count value indicating a number of empty transmissions before implicit release defined for semi-persistent scheduling.

The count value indicating a number of empty transmissions before implicit release defined for semi-persistent scheduling may comprise implicitReleaseAfter.

The specific service may comprise voice transmission, a video service, and/or a service to which semi persistent scheduling is applied.

In addition, according to embodiments, there is provided, for example, a computer program product comprising code means for performing the methods defined above when run on a processing means or module. The computer program product may be embodied on a computer-readable medium, and/or the computer program product may be directly loadable into the internal memory of the computer and/or transmittable via a network by means of at least one of upload, download and push procedures.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIG. 1A shows a simplified structure of an eNB according to an embodiment of the present invention,

FIG. 1B shows a flowchart of a procedure according to an embodiment of the present invention,

FIG. 2 shows a flowchart of a detailed procedure according to an embodiment of the present invention,

FIG. 3 illustrates an example of an SPS scheduling scheme,

FIG. 4 shows an example of a diagram of RSU of VoIP service in 3GPP solution,

FIG. 5 shows an example of MCS and VoIP packet arrival in 3GPP solution for a single-bearer scenario,

FIGS. 6A and 6B show an example of MCS and VoIP packet arrival in 3GPP solution for a multi-bearer scenario,

FIGS. 7A and 7B illustrates MCS and VoIP packet arrival according to the proposed solution according to an embodiment of the invention,

FIG. 8 shows an example of RSU of VoIP service comparison, and

FIG. 9 shows an example of a CELL throughput comparison.

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

In some embodiments of the invention, it is an aim to solve the problem that occurs in connection with SPS, namely that resources reserved for SPS for a particular UE are kept unnecessarily reserved.

This problem is caused by the problem that, in case of a service such as voice (e.g. VoIP or VoLTE), it is not always possible to detect the end of such a service, e.g., the end of a talk spurt, since in particular in a multi-bearer scenario, after the end of the talk spurt the UE might transmit traffic with lower priority on the reserved resource. Hence, when the end of the talk spurt is detected based on empty MAC SDUs, it is not possible to correctly detect the end.

Thus, according to some embodiments of the present invention, a improved way of detecting the end of the talk spurt, or the end of a specific service is provided.

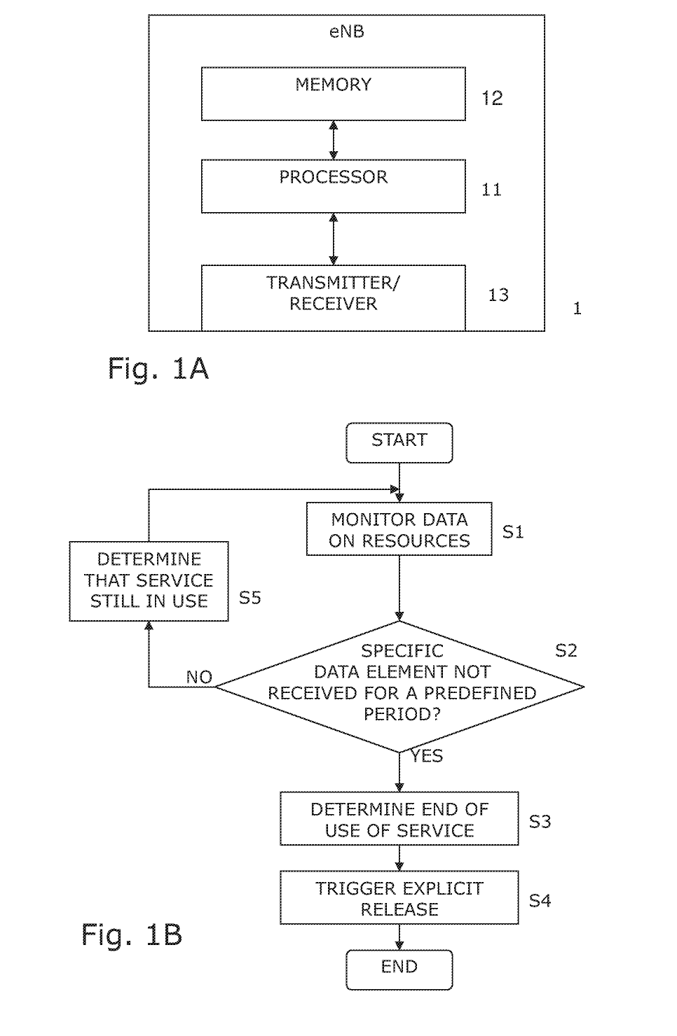

In the following, an embodiment of the present invention is described by referring to FIGS. 1A and 1B.

In particular, FIG. 1A shows an apparatus (e.g. eNB) 1 as an example for network control element. The apparatus may also be a part of the network control element or eNB, for example, the apparatus may be a control element inside the eNB.

The eNB 1 comprises a processor 11 and a memory 12 for storing instructions to be executed by the processor. The processor 11 is configured to carry out the procedure as explained below by referring to FIG. 1B.

The eNB 1 may also comprise a transmitter/receiver 13 which is configured to provide a connection with other network elements.

FIG. 1B shows a method according to the embodiment of the present invention, and may be carried out in the apparatus (e.g. eNB) 1 described above.

The method serves to handle resources, for example, for semi-persistent scheduling (SPS) transmission, wherein the resources are reserved for a specific service. In step S1, data is monitored which is transmitted on the reserved resources and dynamic scheduled resource. In step S2, it is checked whether a specific data element related to the specific service has not been received consecutively for a predefined period on the semi-persistent scheduling reserved resources and dynamic scheduled resource. When the specific data element has not been received for the predefined period (yes in step S2), it is determined in step S3 that the use of the specific service has ended.

In step S4, an explicit release for the reserved resources may be triggered, when it is determined that the use of the specific service has ended. When in step S2 it is determined that the specific data element has been received (no in step S2), it may be determined in step S5 that the specific service is still in use, so that the procedure may be continued.

Thus, by monitoring whether the specific data element is transmitted or not, it can be concluded that, if the specific data element has not been received for a predefined period, the use of the specific service has ended. Therefore, the corresponding resources can be released and used for other purposes, so that the radio resource usage can be improved.

In some embodiments of the invention, the semi-persistent scheduling (SPS) transmission may be an uplink (UL) semi-persistent scheduling (SPS) transmission.

In some embodiments of the invention, the semi-persistent scheduling (SPS) resources may comprise SPS transmission subframes and the dynamic scheduled resource may comprise dynamic scheduling transmission subframes, so that in step S1 data transmitted on consecutive SPS transmission subframes may be monitored and data on a dynamic scheduling transmission subframes may be monitored.

In some embodiments of the invention, the predefined period may be defined as a predefined count value, for example, named as mBRExplicitReleaseAfter. In some embodiments of the invention, the predefined count value (e.g., mBRExplicitReleaseAfter) may be defined such that it is larger than a count value which indicates a number of empty transmissions before implicit release defined for SPS, e.g., a count value implicitReleaseAfter defined for SPS.

In some embodiments, the specific service may be a voice transmission service such as VoIP, video transmission or game services or other services to which SPS can be applied.

In some embodiments of the invention, an example for the specific data element related to the specific service may be a data element indicating a quality of service (QoS) class, e.g., QCI (QoS Class Identifier). For QCI, different levels are defined. For example, for voice transmission usually QCI-1 is used, so that in case the service is voice transmission, the specific data element may by QCI-1 data.

In the following, a more detailed embodiment of the present invention is described.

This embodiment proposes a novel algorithm for the VoLTE talk spurt end detection. That is, in the following embodiment the specific service mentioned above is voice transmission, and the specific data element is QCI-1 data. It is however noted that embodiments of the invention are not limited to this example.

In the embodiment of the invention, an apparatus (e.g. eNB) considers not only on SPS transmission subframe but also the dynamic scheduling transmission subframe. If no specific data element (e.g. QCI-1 data) received on consecutive SPS transmission subframes for the length of a predefined count value mBRExplicitReleaseAfter and no QCI-1 data received on the dynamic scheduling transmission subframe before mBRExplicitReleaseAfter expired, the eNB considers that the talk spurt ends. And when the talk spurt end is detected, an explicit release shall be triggered.

QCI-1 data is data received from QCI1 bearer. Namely, for each bearer, the 4G LTE network assigns a QoS Class Identifier (QCI) level. Each QCI is characterized by resource type of guaranteed or non-guaranteed bit rate, priority during congestion, packet delay budget and a packet error loss rate. These QCIs determine how a bearer is handled all the way from the UE to the packet data network (PDN), inclusive of radio resources and packet data flows. QCI-1 indicates a QCI level to be used for voice transmission.

Using the solution as described above, the UL SPS grant can be released even when the implicit release algorithm cannot detect the end of talk spurt accurately, such as in the scenario of UE with simultaneous data and voice service. That is because, when the Voice talk spurt period ends, there will be no more QCI-1 data transmitted in any transmission subframe. Then after detection of consecutive mBRExplicitReleaseAfter times no QCI-1 data transmission on SPS transmission subframes, and no QCI-1 data transmission on the dynamic scheduling transmission subframes for the whole detection period, the UL SPS grant will be explicitly released by eNB.

For an implementation of the above described embodiment, the following three points can be considered.

1.) Determination of the count value mBRExplicitReleaseAfter.

To work together with SPS implicit release function in the scenario of UE with voice service only, mBRExplicitReleaseAfter shall be larger than implicitReleaseAfter. For example, it can be set:

mBRExplicitReleaseAfter=implicitReleaseAfter+1.

2.) Maintenance of empty data (e.g. QCI-1 data) reception counter:
a) The counter is initialized to zero at the beginning;
b) After detection of empty QCI-1 data received on SPS transmission subframe, increases the counter by one;
c) After detection of QCI-1 data received on either SPS transmission subframe or dynamic scheduling transmission subframe, reset the counter to zero;
d) At the point of implicit release triggered, the counter is reset to zero.
3.) Explicit release trigger

Furthermore, the relation between the empty QCI-1 data reception counter and mBRExplicitReleaseAfter is checked after each time of the counter increment, once the counter equals the count value mBRExplicitReleaseAfter, eNB shall trigger explicit release for the user to release the UL SPS grant.

That is, when it is determined that the period has elapsed when a certain value is reached, the certain value is zero in this alternative example.

It is noted that as an alternative example, it is possible to initialize the counter to a count value mBRExplicitReleaseAfter and then decrease the counter by one, i.e., to decrement the counter, and to trigger explicit release when the counter is zero. That is, when it is determined that the period has elapsed when a certain value is reached, the certain value is zero in this alternative example.

In the above description, the term “empty QCI-1 data” means that no QCI-1 data is received.

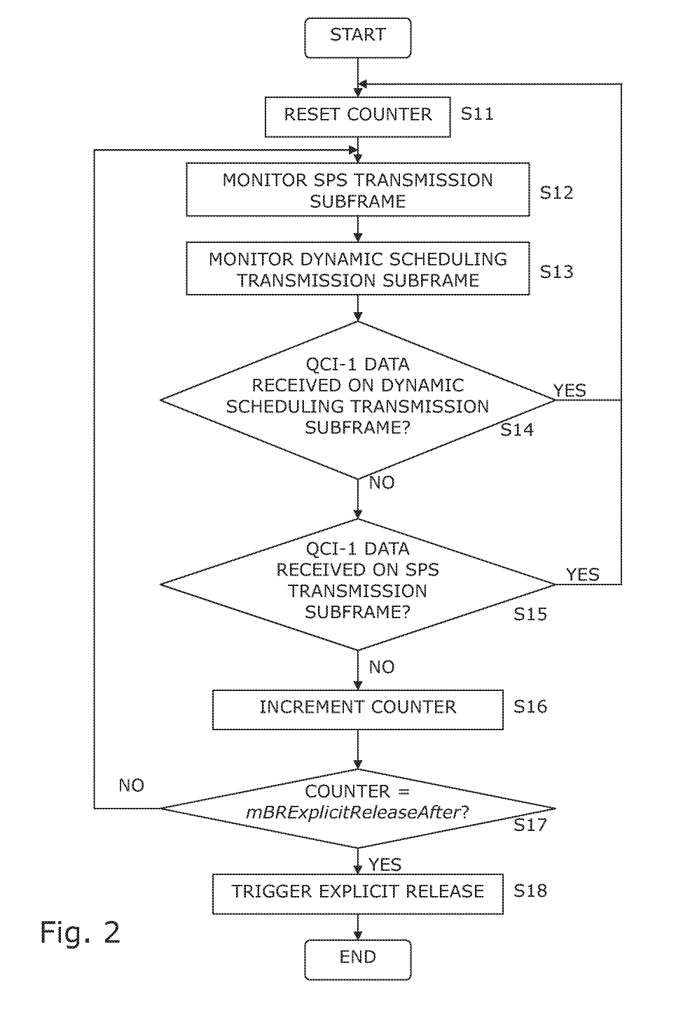

In the following, the above procedures are described by referring to a flowchart shown in FIG. 2.

At the beginning of the procedure, in step S11, the counter is reset. In steps S12 and S13, SPS transmission subframe and dynamic scheduling transmission subframes are monitored, respectively. In steps S14 and S15, it is checked whether QCI-1 data is received on either SPS transmission subframe or dynamic scheduling transmission subframe. In case QCI-1 data is received on the SPS transmission subframe or the dynamic scheduling transmission subframe. If this is the case (yes in step S14 or in step S15), then the counter is reset in S11, and the procedure starts again. If no QCI-1 data is received on the dynamic scheduling transmission subframe (no in step S14) and in particular no QCI-1 data is received on the SPS transmission subframe (no in step S15), then the counter is incremented in step S16. In step S17, it is checked whether the counter value has reached mBRExplicitReleaseAfter. If so (yes in step S17), eNB triggers an explicit release in S18. If not (no in step S17), the procedure returns to the monitoring in step S12.

It is noted that the flowchart shown in FIG. 2 gives only an example, and other implementations are possible. For example, the order of the steps may be different.

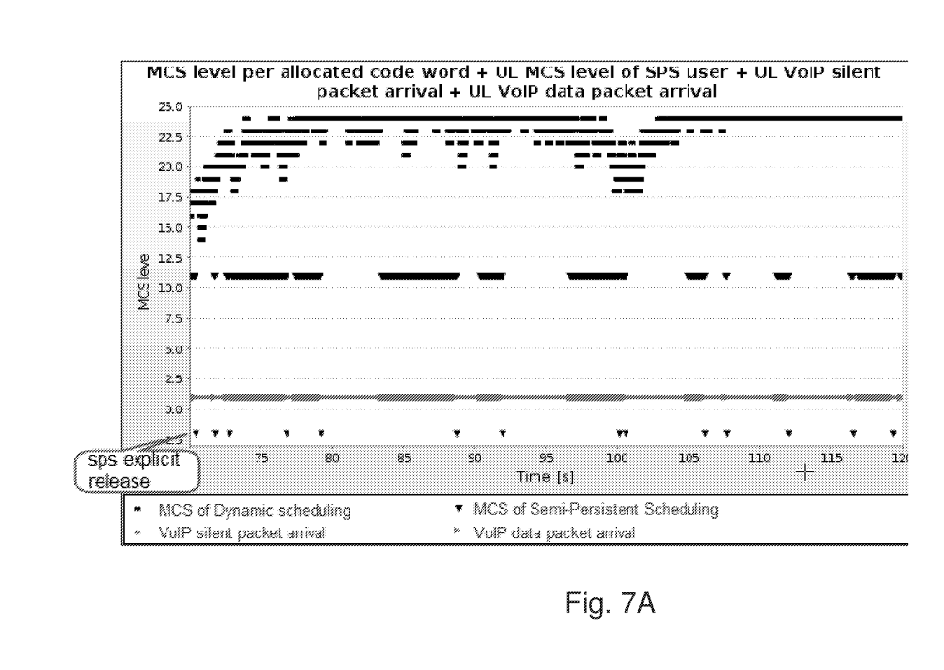

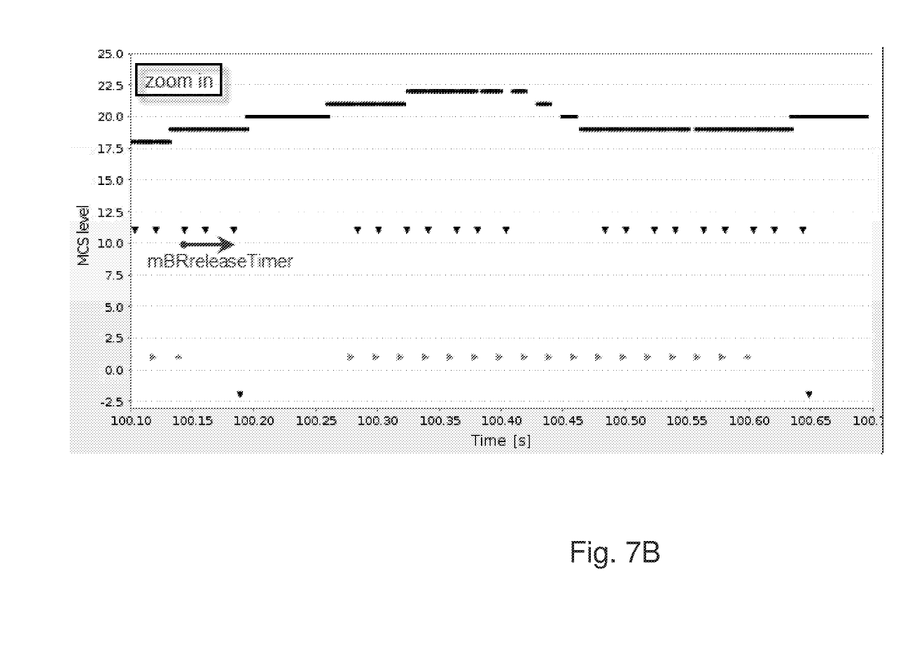

Some examples for simulation results using the solution according to the above embodiment of the present invention are illustrated in FIGS. 7A, 7B, 8 and 9. It is noted that these are only examples and different results may be get using different implementations.

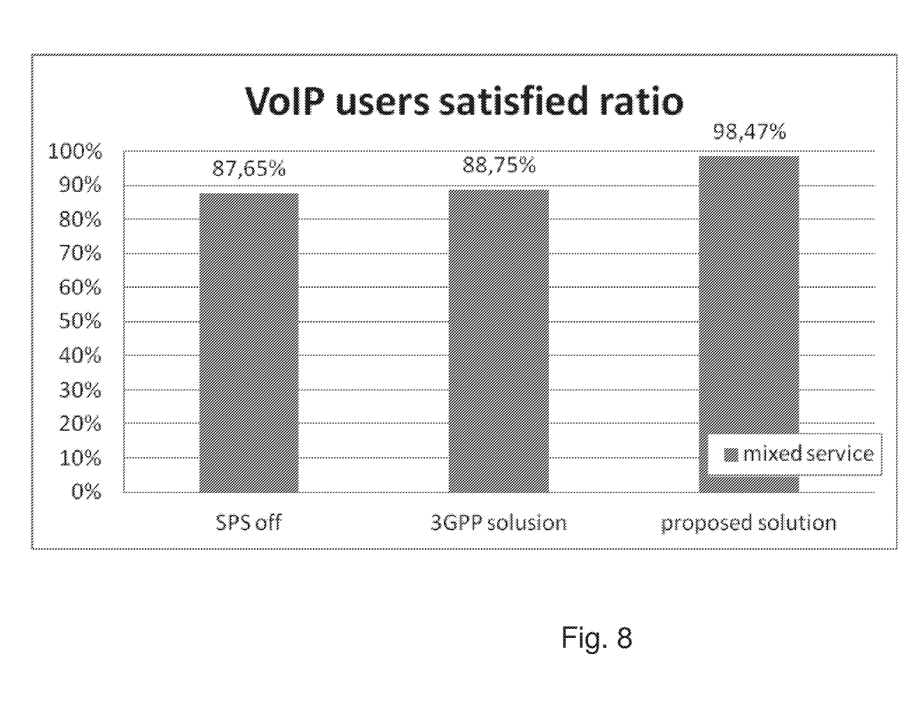

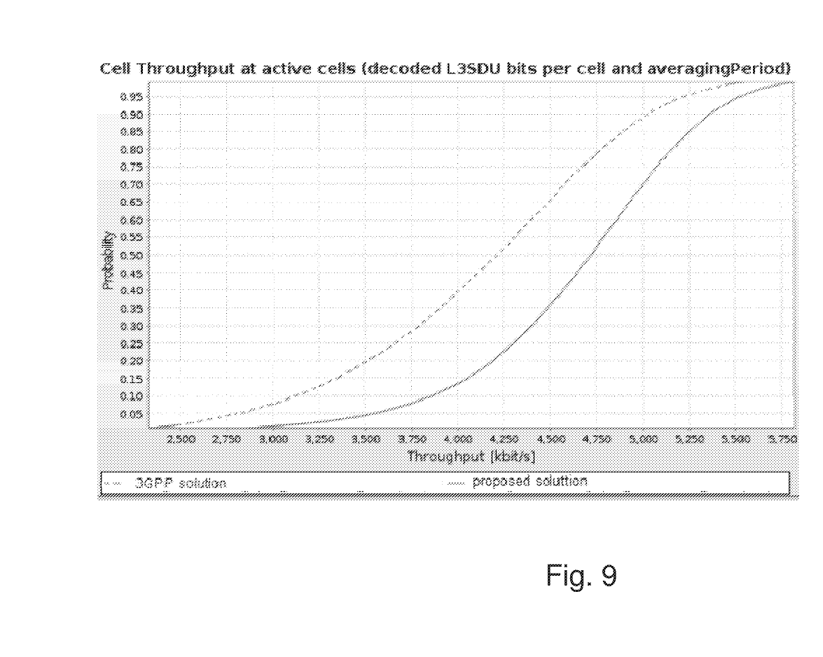

In particular, FIGS. 7A and 7B illustrates MCS and VoIP packet arrival according to the proposed solution according to the embodiment. Once no QCI-1 data is received on consecutive SPS transmission subframes and no QCI-1 data is received on the dynamic scheduling transmission subframe for the length of a predefined period, the eNB considers that the talk spurt ends and triggers the explicit release. The solution according to some embodiments of the present invention can work well in the multi-bearer scenario. FIG. 8 shows RSU of VoIP service comparison. In the multi-bearer scenario, the performance can be improved with the solution according to some embodiments of the present invention. FIG. 9 shows a CELL throughput comparison. Using the solution according to some embodiments of the present invention, the cell throughput can be improved in the multi-bearer scenario.

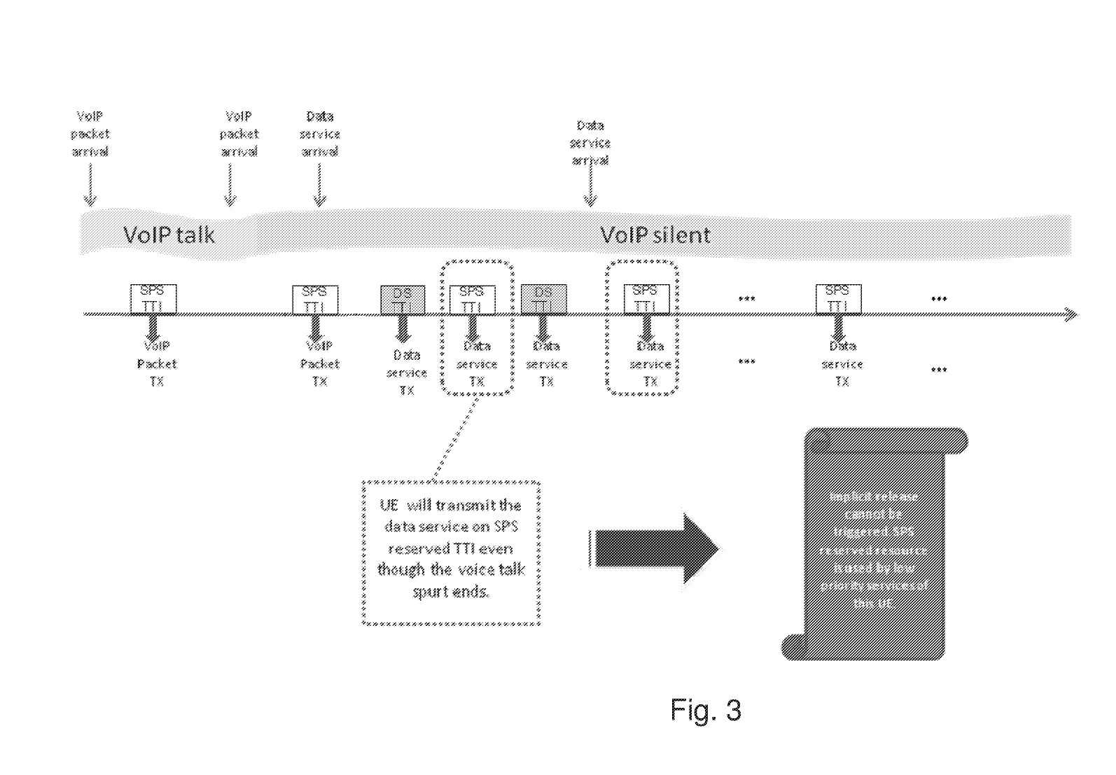

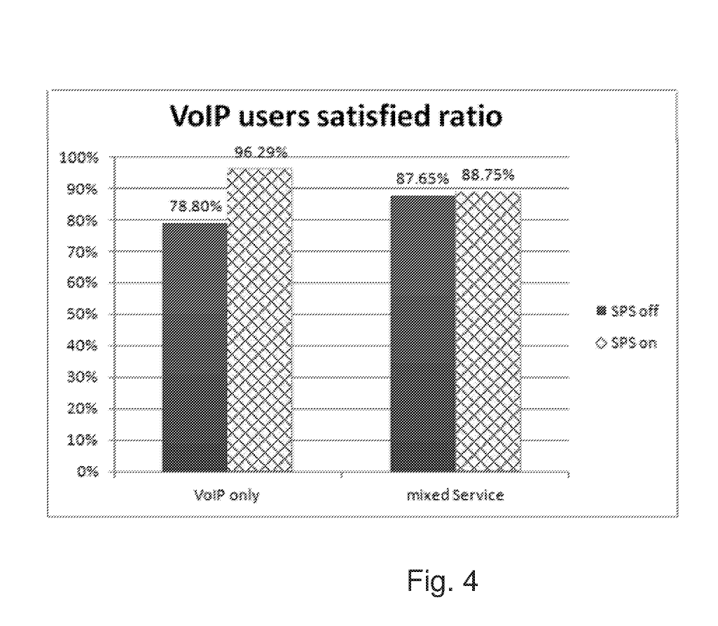

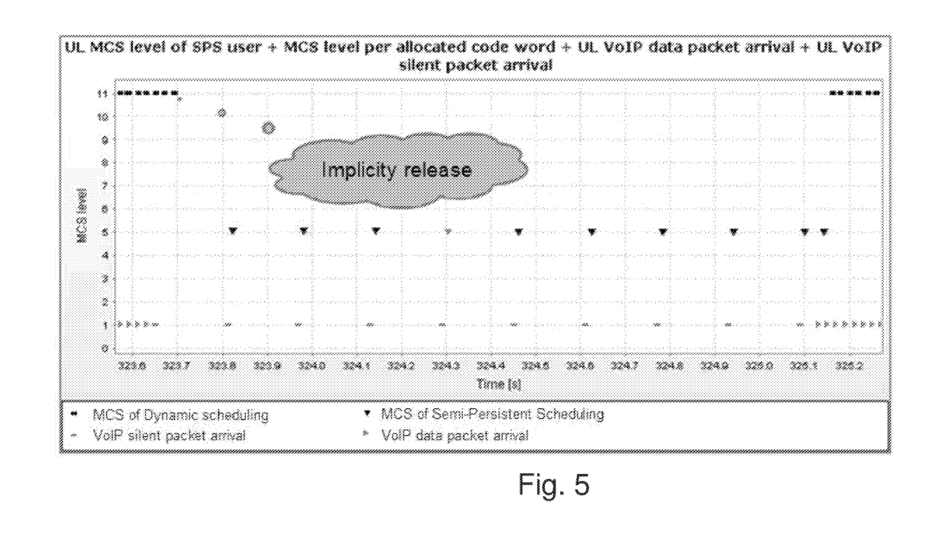

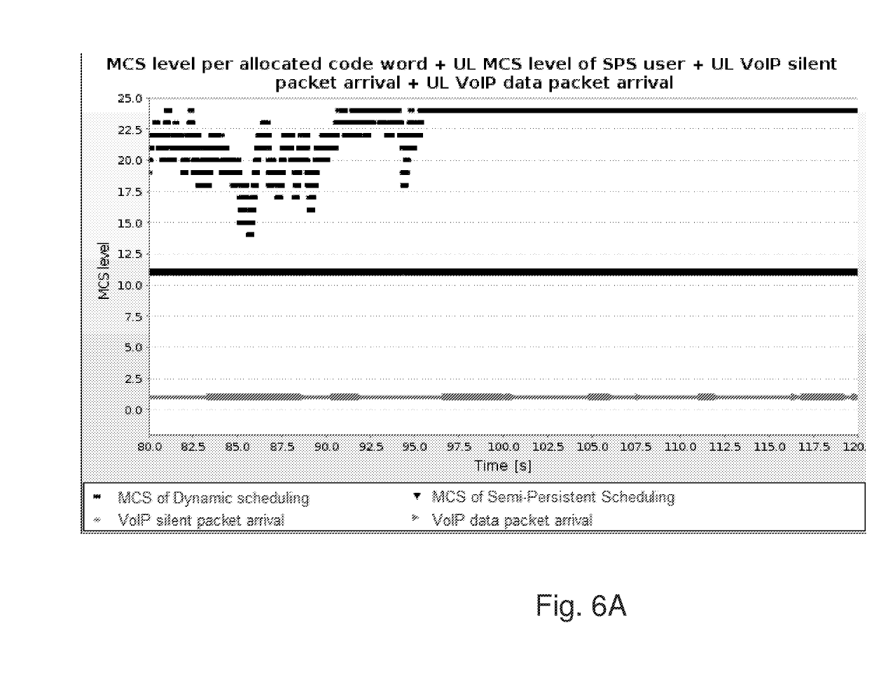

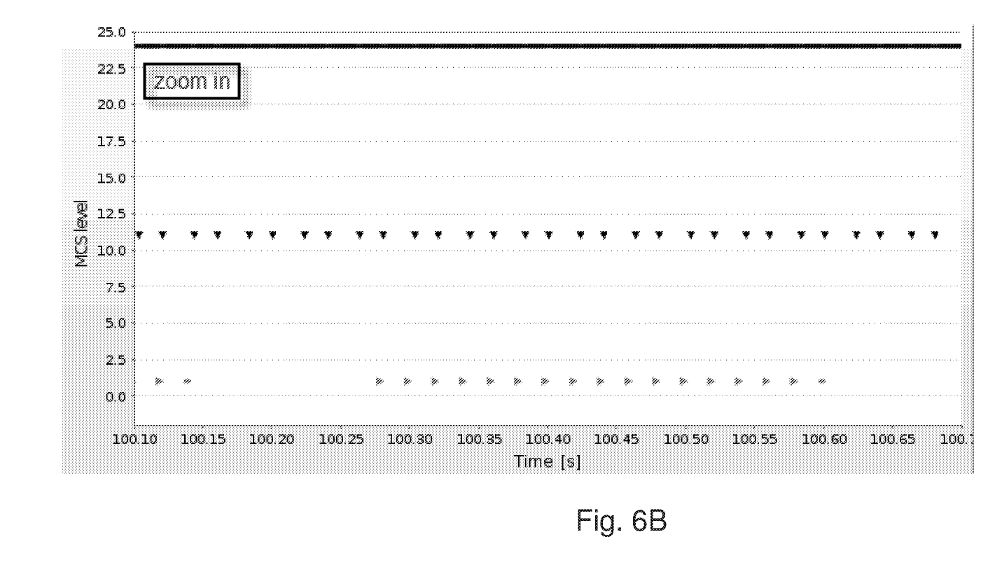

As derivable from FIGS. 7A, 7B, 8 and 9, in particular when comparing them to the prior art simulation results given in FIGS. 3, 4, 5, 6A and 6B, the solution according to some embodiments of the present invention may achieve an improvement, which is in particular caused by the improved radio resource usage.

Hence, summarizing, according to an embodiment of the present invention, an algorithm for the voice talk spurt end detection is provided: eNB considers not only on SPS transmission subframe but also the dynamic scheduling transmission subframe. If no QCI-1 data received on consecutive SPS transmission subframes for a predefined count value mBRExplicitReleaseAfter and no QCI-1 data received on the dynamic scheduling transmission subframe before mBRExplicitReleaseAfter expired, the eNB considers that the talk spurt ends. And when the talk spurt end is detected, an explicit release shall be triggered.

Therefore, UL SPS grant can be released even when the implicit release algorithm cannot detect the end of talk spurt accurately, such as in the scenario of UE with simultaneous data and voice service. That is because, when the voice talk spurt period ends, there will be no more QCI-1 data transmitted in any transmission subframe. Then after detection of consecutive mBRExplicitReleaseAfter times no QCI-1 data transmission on SPS transmission subframes, and no QCI-1 data transmission on the dynamic scheduling transmission subframes for the whole detection period, the UL SPS grant will be explicitly released by eNB.

It is noted that the present invention is not limited to the embodiments described above. In particular, modifications and variations are possible.

For example, in the above embodiments QCI-1 data was described as an example for the specific data element related to a specific service. However, also other kinds of data elements may be used by which it can be detected whether a certain service is still in use. For example, also other QCI levels may be used. Moreover, the specific data element may be any kind of a data element which is related to the specific service, so that, when this specific data element is not received, it can be concluded that the service is no longer used.

Moreover, a voice transmission service such as VoIP was described as the specific service. However, also other service may be applied. For example, embodiments are also applicable to video services or game services or other services to which SPS transmission may be applied. These services may include services which require real time transmission, but are not limited thereto.

Furthermore, in some embodiments described above the predefined period was detected by means of a counter. However, embodiments of the present invention are not limited to this. For example, the predefined period may also be detected by means of timer which is configured to detect whether a predefined time period has elapsed.

According to another example of embodiments, there is provided an apparatus comprising means for handling resources for semi-persistent scheduling transmission, wherein the resources are reserved periodically for a specific service; means for monitoring data transmitted on the semi-persistent scheduling reserved resources and dynamic scheduled resource; means for checking whether a specific data element related to the specific service has not been received consecutively for a predefined period on the semi-persistent scheduling reserved resources and dynamic scheduled resource; and means for determining, when the specific data element has not been received for the predefined period, that the use of the specific service has ended.

Furthermore, according to some other examples of embodiments, the above defined apparatus may further comprise means for conducting at least one of the processings defined in the above described methods, for example a method according that described in connection with FIG. 1B or FIG. 2.

Embodiments of the present invention are applicable to any system in which semi-persistent scheduling (SPS) applied and the reserved resource is implicit released by counting empty SDU receptions on the semi-Persistent reserved resource. For example, some embodiments of the present invention are applicable to LTE, TDD LTE, FDD LTE etc.

It is to be understood that any of the above modifications can be applied singly or in combination to the respective aspects and/or embodiments to which they refer, unless they are explicitly stated as excluding alternatives.

For the purpose of the present invention as described herein above, it should be noted that
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above, eNode-B etc. as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

It is noted that the embodiments and examples described above are provided for illustrative purposes only and are in no way intended that the present invention is restricted thereto. Rather, it is the intention that all variations and modifications be included which fall within the spirit and scope of the appended claims.

1. A method for handling resources for semi-persistent scheduling transmission, wherein the resources are reserved periodically for a specific service, the method comprising
monitoring data transmitted on the semi-persistent scheduling reserved resources and dynamic scheduled resource,
checking whether a specific data element related to the specific service has not been received consecutively for a predefined period on the semi-persistent scheduling reserved resources and dynamic scheduled resource, and
determining, when the specific data element has not been received for the predefined period, that the use of the specific service has ended.

2. The method according to claim 1, wherein the semi-persistent scheduling resources comprise semi-persistent scheduling transmission subframes and the dynamic scheduled resource comprises dynamic scheduling transmission subframes, and the monitoring of data comprises
monitoring data transmitted on consecutive semi-persistent scheduling transmission subframes on the reserved resource, and
monitoring data on the dynamic scheduling transmission subframes,
wherein it is checked whether the specific data element has not been received on consecutive semi-persistent scheduling transmission subframes and on the dynamic scheduling transmission subframes.

3. The method according to claim 1, further comprising
triggering an explicit release for the semi-persistent scheduling reserved resources when it is determined that the use of the specific service has ended.

4. The method according to claim 2, wherein
the predefined period is monitored by means of a counter, the method further comprising
incrementing or decrementing the counter each time a semi-persistent scheduling transmission subframe is received in which no specific data element related to the specific service is detected, wherein
it is determined that the period has elapsed when a certain value is reached.

5. The method according to claim 4, further comprising
resetting the counter upon detecting the specific data element on a semi-persistent scheduling transmission subframe and/or the dynamic scheduling transmission subframes.

6. The method according to claim 1, wherein
the predefined period is defined by a predefined count value, wherein the predefined count value is defined such that it is larger than a count value indicating a number of empty transmissions before implicit release defined for semi-persistent scheduling.

7. The method according to claim 6, wherein the count value indicating a number of empty transmissions before implicit release defined for semi-persistent scheduling comprises implicitReleaseAfter.

8. The method according to claim 1, wherein
the specific service comprises voice transmission, a video service, and/or a service to which semi persistent scheduling is applied.

9. An apparatus comprising
at least one processing circuitry, and
at least one memory for storing instructions to be executed by the processing circuitry, wherein
the at least one memory and the instructions are configured to, with the at least one processing circuitry, cause the apparatus at least:
to handle resources for semi-persistent scheduling transmission, wherein the resources are reserved periodically for a specific service,
to monitor data transmitted on the semi-persistent scheduling reserved resources and dynamic scheduled resource,
to check whether a specific data element related to the specific service has not been received consecutively for a predefined period on the semi-persistent scheduling reserved resources and dynamic scheduled resource, and
to determine, when the specific data element has not been received for the predefined period, that the use of the specific service has ended.

10. The apparatus according to claim 9, wherein the semi-persistent scheduling resources comprise semi-persistent scheduling transmission subframes and the dynamic scheduled resource comprises dynamic scheduling transmission subframes, and
the at least one memory and the instructions are further configured to, with the at least one processing circuitry, cause the apparatus at least:
to monitor data transmitted on consecutive semi-persistent scheduling transmission subframes on the reserved resource,
to monitor data on the dynamic scheduling transmission subframes, and
to check whether the specific data element has not been received on consecutive semi-persistent scheduling transmission subframes and on the dynamic scheduling transmission subframes.

11. The apparatus according to claim 9, wherein the at least one memory and the instructions are further configured to, with the at least one processing circuitry, cause the apparatus at least:
to trigger an explicit release for the semi-persistent scheduling reserved resources when it is determined that the use of the specific service has ended.

12. The apparatus according to claim 10 or 11, wherein the at least one memory and the instructions are further configured to, with the at least one processing circuitry, cause the apparatus at least:
to monitor the predefined period by means of a counter,
to increment or decrement the counter each time a semi-persistent scheduling transmission subframe is received in which no specific data element related to the specific service is detected, and
to determine that the period has elapsed when a certain value is reached.

13. The apparatus according to claim 12, wherein the at least one memory and the instructions are further configured to, with the at least one processing circuitry, cause the apparatus at least:
to reset the counter upon detecting the specific data element on a semi-persistent scheduling transmission subframe and/or the dynamic scheduling transmission subframes.

14. The apparatus according to any one of the claims 9 to 13 claim 9, wherein
the predefined period is defined by a predefined count value, wherein the predefined count value is defined such that it is larger than a count value indicating a number of empty transmissions before implicit release defined for semi-persistent scheduling.

15. The apparatus according to claim 14, wherein the count value indicating a number of empty transmissions before implicit release defined for semi-persistent scheduling comprises implicitReleaseAfter.

16. The apparatus according to claim 9, wherein
the specific service comprises voice transmission, a video service, and/or a service which semi persistent scheduling applied.

17.-18. (canceled)

19. A computer program embodied on a non-transitory computer readable medium, configured to control a processor to perform a method, the method comprising
handling resources for semi-persistent scheduling transmission, wherein the resources are reserved periodically for a specific service,
monitoring data transmitted on the semi-persistent scheduling reserved resources and dynamic scheduled resource,
checking whether a specific data element related to the specific service has not been received consecutively for a predefined period on the semi-persistent scheduling reserved resources and dynamic scheduled resource, and
determining, when the specific data element has not been received for the predefined period, that the use of the specific service has ended.

20.-27. (canceled)
